(19) United States
(12) Patent Application Publication
(10) Pub. No.: US 2026/0057350 A1
(43) Pub. Date: Feb. 26, 2026

(54) Automated Meeting Agenda Time Estimation With Adaptive Scaling

(71) Applicant: Zoom Communications, Inc., San Jose, CA (US)

(72) Inventor: Nick Swerdlow, Santa Clara, CA (US)

(21) Appl. No.: 19/371,503

(22) Filed: Oct. 28, 2025

Related U.S. Application Data
(63) Continuation of application No. 17/444,050, filed on Jul. 29, 2021.

(51) Int. Cl. G06Q 10/1093; G06N 20/00; G06Q 10/1091

(52) U.S. Cl. CPC G06Q 10/1093; G06N 20/00; G06Q 10/1091

(57) ABSTRACT

An input to schedule a future conference is received. The input identifies a list of topics and a total time scheduled for the future conference. Time allotments for the list of topics are determined based on historical conference data. The time allotments are scaled based on a total time weight indicative of the total time to generate scaled time allotments within that total time. A schedule item for the future conference is then updated to include the scaled time allotments for the list of topics

### CROSS REFERENCE TO RELATED APPLICATIONS

This application is a continuation of U.S. Patent Application Serial No. 17/444,050, filed July 29, 2021, the entire disclosure of which is incorporated herein by reference.

### BACKGROUND

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises systems, meaning that remote workers and those who are generally increasingly mobile may be unable to rely upon them. One type of system which addresses problems such as these includes a unified communications as a service (UCaaS) platform, which includes several communications services integrated over a network, such as the Internet, to deliver a complete communication experience regardless of physical location.

### SUMMARY

Disclosed herein are, inter alia, implementations of systems and techniques for future conference time allotment intelligence.

One aspect of this disclosure is a method, which includes detecting a list of topics for a future conference responsive to an input to schedule the future conference, determining time allotments for the list of topics based on an output of a learning model trained to process historical conference data associated with topic speaking time and participant speaking time, and updating a schedule item including the list of topics according to the time allotments.

Another aspect of this disclosure is an apparatus, which includes a memory and a processor configured to execute instructions stored in the memory to determine time allotments for a list of topics for a future conference based on an output from a learning model trained for historical conference data processing, and include the time allotments in connection with the list of topics in a schedule item for the future conference.

Yet another aspect of this disclosure is a non-transitory computer readable medium storing instructions operable to cause one or more processors to perform operations, which include determining time allotments for a list of topics for a future conference based on historical conference data associated with topic speaking time and participant speaking time, and including the time allotments in connection with the list of topics in a schedule item for the future conference.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a future conference time allotment intelligence system.

FIG. 5 is a block diagram of example functionality of conference scheduling intelligence software.

FIG. 6 is a block diagram of an example of conference scheduling intelligence functionality of a future conference time allotment intelligence system.

FIG. 7 is a flowchart of an example of a technique for future conference time allotment intelligence.

FIG. 8 is a flowchart of an example of a technique for using conference transcription information to update historical data stores for future conference time allotment intelligence.

### DETAILED DESCRIPTION

Business of all types of industry rely upon conferences to effectively discuss lists of topics and complete internal tasks. A conference, which may be between two or more participants, is typically scheduled by an invitation represented by a calendar appointment being placed on the schedules of those participants. The invitation generally includes information for connecting to the conference over one or more clients, such as using a web browser, a mobile application, or a phone. Scheduling a conference further includes understanding what topics will be discussed and which participants should be invited to attend. In many cases, the list of topics to be discussed may be included in the conference invitation.

In most cases, a conference is scheduled for a rounded period of time (e.g., 30, 60, or 90 minutes) based on an extent of the list of topics to be discussed. However, this process requires the person scheduling the conference to simply estimate the amount of time which will be required to address all of those topics. As such, it is subject to error based on topics taking longer to discuss than anticipated or conference participants derailing the conversation by taking up too much time on something else. Furthermore, conventional conferencing systems lack intelligence for estimating time allotments, such as due to limitations in data sets required for training an intelligence aspect such as a machine learning model for time allotment intelligence.

Implementations of this disclosure address problems such as these using future conference time allotment intelligence, by which time allotments for a list of topics are intelligently determined for a future conference and included in a schedule item for the future conference. The list of topics is detected and used to retrieve historical conference data from one or more data stores. The historical conference data indicates talk times for various participants and/or topics and is used to determine time allotments for the topics of the list of topics. The schedule item for the future conference is then updated to include those determined time allotments.

The implementations of this disclosure are described with respect to conferences; however, it should be understood that the implementations of this disclosure could also or instead be used for telephone calls. That is, generally, a conference is a communication between two or more participants over a conference service, and a call is a communication between two or more participants over a telephony service. Both a telephony service and a conference service may be used to support multi-participant communications. The conference time allotment intelligence implementations as disclosed herein may thus be performed for both conferences and calls.

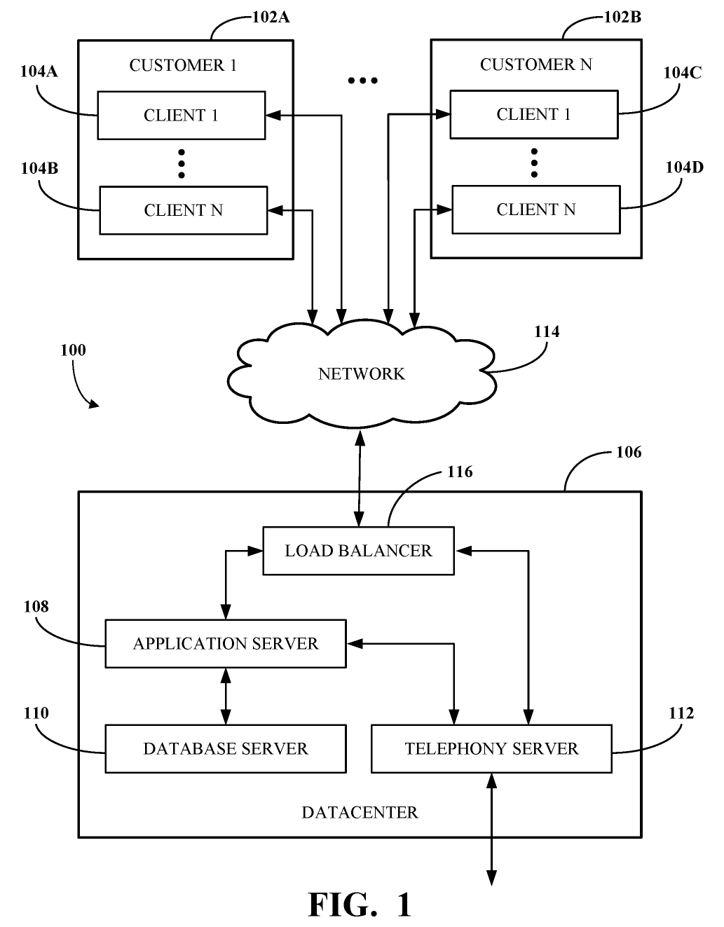

To describe some implementations in greater detail, reference is first made to examples of hardware and software structures used to implement a system for future conference time allotment intelligence. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, one or more of the clients 104A through 104D or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to ease the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106.

For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

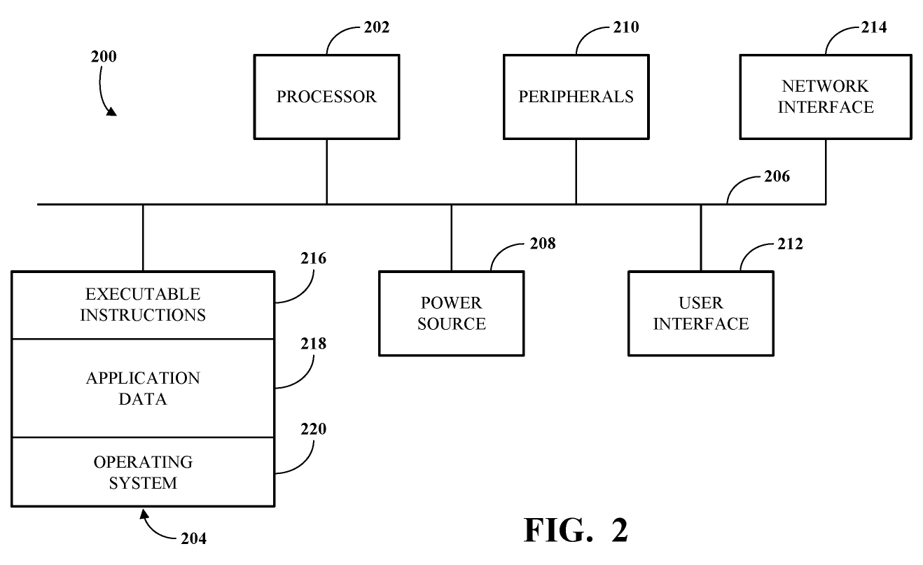

FIG. 2 is a block diagram of an example internal configuration of a computing device 200 of an electronic computing and communications system. In one configuration, the computing device 200 may implement one or more of the clients 104A through 104D, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR SDRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

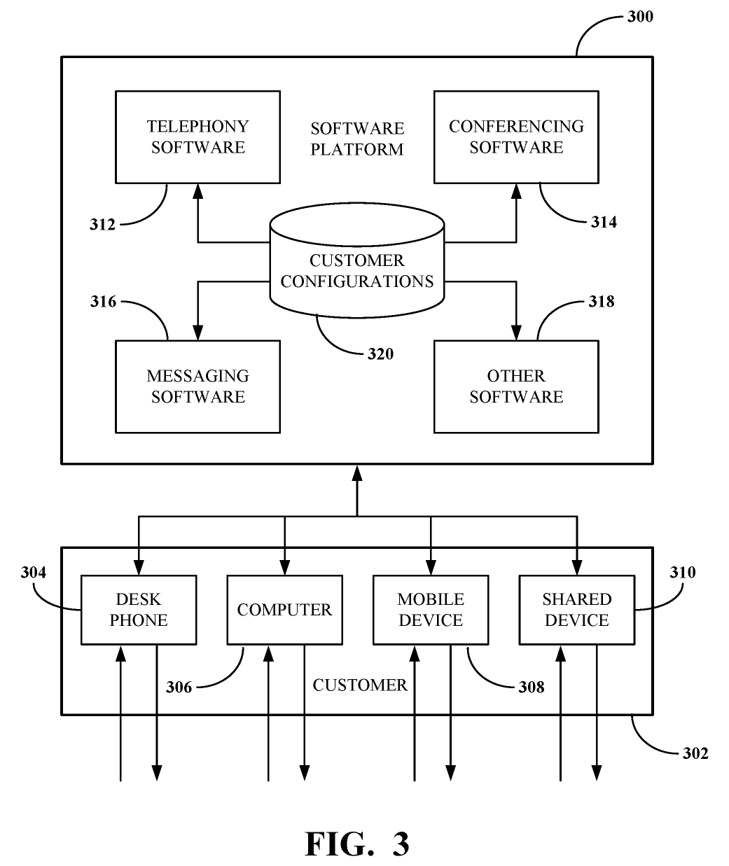

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients 304 through 310 (e.g., the clients 304, 306, 308, 310) – a desk phone, a computer, a mobile device, and a shared device. The desk phone is a desktop unit configured to at least send and receive calls and includes an input device for receiving a telephone number or extension to dial to and an output device for outputting audio and/or video for a call in progress. The computer is a desktop, laptop, or tablet computer including an input device for receiving some form of user input and an output device for outputting information in an audio and/or visual format. The mobile device is a smartphone, wearable device, or other mobile computing aspect including an input device for receiving some form of user input and an output device for outputting information in an audio and/or visual format. The desk phone, the computer, and the mobile device may generally be considered personal devices configured for use by a single user. The shared device is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools, but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, amongst the clients 304 through 310 be sent or received using the desk phone, a softphone running on the computer, a mobile application running on the mobile device, or using the shared device that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include software for intelligently recommending time allotments for topics to discuss during future conferences.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some or all of the software 312 through 318 may be combined into a single software application run on clients of the customer, such as one or more of the clients 304 through 310.

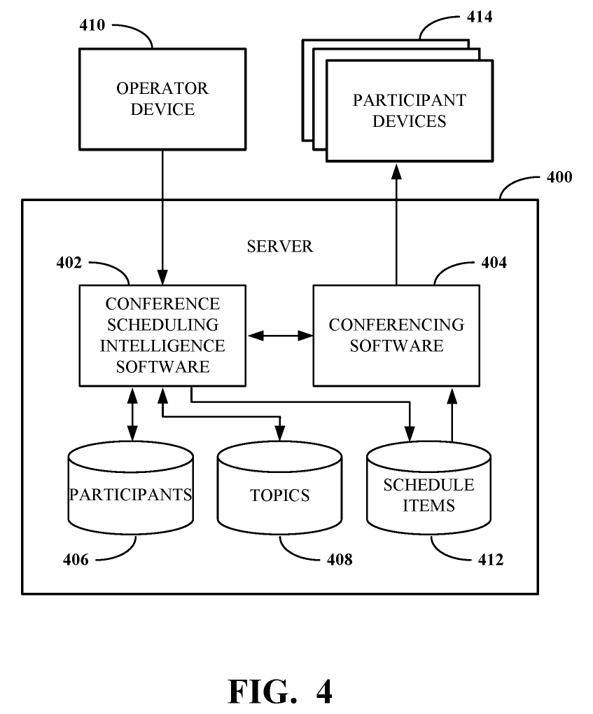

FIG. 4 is a block diagram of an example of a future conference time allotment intelligence system. A server 400 is a computing aspect including hardware and/or software for future conference time allotment intelligence. As shown, the server 400 runs conference scheduling intelligence software 402 including intelligence functionality for determining time allotments for a list of topics to discuss in a future conference and conferencing software 404 for later facilitating that future conference. The server 400 may be used to deliver services of a software platform, such as a UCaaS platform. For example, the server 400 may be the application server 108 shown in FIG. 1. Although a single server 400 is shown, in some implementations, a first server may run the conference scheduling intelligence software 402 and a second server may run the conferencing software 404. Although the conference scheduling intelligence software 402 and the conferencing software 404 are shown as separate software aspects, in some implementations, the conferencing software 404 may include the conference scheduling intelligence software 402.

The conference scheduling intelligence software 402 leverages historical data associated with participants of past conferences and/or topics discussed in past conferences to determine time allotments for a list of topics identified for discussion within a future conference. In particular, the conference scheduling intelligence software 402 is configured to access one or more data stores at the server 400 or elsewhere to obtain information associated with topics relevant to the future conference and/or persons identified as potential participants in the future conference. As shown, the conference scheduling intelligence software 402 is configured to access a participant data store 406 which stores historical data associated with participants of past conferences and a topic data store 408 which stores historical data associated with topics discussed in past conferences.

The historical data associated with participants of past conferences represents talk times across one or more conferences for individual participants regardless of topic and in some cases frequency of attendance by individual participants. For example, for a given participant who has attended one or more past conferences, a record in the participant data store 406 may identify a total amount of time the participant spoke during a given past conference, an average amount of time the participant spoke across all of those past conferences, and a number of the past conferences attended by the participant.

The historical data associated with topics discussed in past conferences represents talk times across one or more conferences by various participants and in some cases frequency of presence on lists of topics discussed within past conferences. For example, for a given topic which was discussed in one or more past conferences, a record in the topic data store 408 may identify a total amount of time the topic was discussed during a given past conference, an average amount of time the topic has been discussed across all of those past conferences, and a number of the past conferences during which the topic has been discussed.

Historical data within one or both of the participant data store 406 or the topic data store 408 may be produced by contextual processing of transcriptions of past conferences and/or lists of topics for those past conferences. For example, a transcription of a conference can be processed to determine start and end talk times for the discussion of a topic based on keyword and context processing and start and end talk times for individual participant speech. The transcription may be recorded by or for the conferencing software 404, which may, for example, be the conferencing software 314 shown in FIG. 3. The transcription may be transmitted to the conference scheduling intelligence software 402 from the conferencing software 404 or from other software which generated it (e.g., automated speech recognition software separate from the conferencing software 404). A machine learning model at or otherwise used by the conference scheduling intelligence software 402 then processes the transcription, such as by computing total talk times for participants and topics, to produce output which is stored as the historical data in one or both of the participant data store 406 or the topic data store 408.

The conference scheduling intelligence software 402 receives input including a list of topics for a future conference from an operator device 410 used to schedule the future conference and produces output including either determined time allocations for those topics or an updated schedule item for the future conference according to those determined time allocations. The time allocations for the list of topics are determined using a machine learning model trained for processing historical conference data. In particular, the machine learning model processes the list of topics against the data stored in one or both of the participant data store 406 or the topic data store 408 to determine time allotments for the topics of the list of topics. The time allotments determined by the conference scheduling intelligence software 402 represent recommended amounts of time to spend discussing those topics during the subject future conference.

In some implementations, the conference scheduling intelligence software 402 may use one or more scaling factors to scale the time allotments determined for the future conference. Examples of scaling factors which may be used by the conference scheduling intelligence software 402 include, without limitation, a total time weight that scales one or more time allotments based on a total amount of time for which the future conference will be scheduled, a temporal relevance weight that scales one or more time allotments based on how soon an event associated with the corresponding topics is to the future conference, a total participants weight that scales one or more time allotments based on a total number of potential participants for the future conference exceeding a threshold (e.g., 5 or 10) and/or based on historical data not being available for one or more of those potential participants, and a topic frequency weight that scales one or more time allotments based on a frequency of conferences during which corresponding topics are discussed.

The scaling factors may be used to scale (i.e., increase or decrease) one or more of the time allotments determined by the conference scheduling intelligence software 402. For example, without a total time weight, the conference scheduling intelligence software 402 may determine by processing historical data stored in one or both of the participant data store 406 or the topic data store 408 that time allotments for three topics should respectively be 15 minutes, 20 minutes, and 25 minutes. However, where a total time weight for the future conference is identified and indicates that only 30 minutes are available for the future conference, the conference scheduling intelligence software 402 may instead scale down the determined time allotments to 7.5 minutes, 10 minutes, and 12.5 minutes, respectively. In another example, with the temporal relevant weight, where one or more of the topics in the list of topics corresponds to an event that is several months away from the planned date of the future conference, the time allotments for those one or more topics may be scaled down; however, where that event is only one or two weeks away, those time allotments may be scaled up. In yet another example, with the topic frequency weight, where a topic is included in regularly occurring conferences (e.g., weekly or bi-weekly), the time allotment corresponding thereto may be scaled down; however, where that topic has not been discussed in some time, such as because some number of those regularly occurring conferences have been skipped or canceled, the time allotment corresponding thereto may instead be scaled up.

In some implementations, the input received from the operator device 410 may identify potential participants to invite to the future conference. In some implementations, the conference scheduling intelligence software 402 can identify potential participants to invite to the future conference based on the list of topics. For example, a machine learning model of or otherwise used by the conference scheduling intelligence software 402 can evaluate the list of topics based on content and context against a set of data representing skills, past projects, organization chart information, and/or job title information for various personnel associated with an organization to determine one or more persons who are likely to be knowledgeable about one or more topics of the list of topics. Once identified, historical data associated with those potential participants can be obtained from the participant data store 406 such as to determine time allotments for the list of topics based on historical talk time information for those potential participants from past conferences.

The determined time allotments are used to update a schedule item for the future conference. The schedule item is a data aspect which communicates information about the future conference to one or more potential participants thereof. For example, the schedule item may be an invitation to join the future conference, such as a calendar invitation. The schedule item includes the list of topics and the time allotments. In some cases, the schedule item is created based on input from the operator device 410, in which case the schedule item may or may not include initial time allotments for the topics of the list of topics.

Where the schedule item includes initial time allotments, the conference scheduling intelligence software 402 can update the initial time allotments within the schedule item according to the determined time allotments. Otherwise, where the schedule item does not include initial time allotments, the conference scheduling intelligence software 402 can add the determined time allotments to the schedule item. In other cases, the schedule item is created based on the determination of the time allotments, such as in response to input indicating the list of topics from the operator device 410. In either case, once the schedule item is created, information associated therewith is stored in a schedule item data store 412 until the future conference starts. When the future conference starts, or shortly before or after same, the stored schedule item information may be made available to one or more participant devices 414 connecting to the future conference through the conferencing software 404 which implements it.

In some implementations, the conference scheduling intelligence software 402 may monitor the creation of the schedule item for the future conference in real-time and present the determined time allotments for individual topics immediately in response to those topics being listed, such as based on input received from the operator device 410 identifying a new topic. In some implementations, the conference scheduling intelligence software 402 may automatically transmit the schedule item including the updates according to the determined time allotments to the participant devices 414 in response to those updates.

Information from the future conference is used after that conference has been completed to update one or both of the participant data stored in the participant data store 406 or the topic data stored in the topic data store 408. For example, the information from the completed conference may be or refer to information obtained from a transcription of the completed conference recorded by or for the conferencing software 404. The transcription may be transmitted to the conference scheduling intelligence software 402 from the conferencing software 404 or from other software which generated it (e.g., automated speech recognition software separate from the conferencing software 404). In another example, the information from the conference may be or refer to information measured by the conferencing software 404.

The information from the conference indicates times during the conference for which certain participants spoke and/or certain topics were discussed. A machine learning model at or otherwise used by the conference scheduling intelligence software 402 may then be used to update the historical data to be used for later conferences based on transcription or other information obtained for a given conference. For example, the output of the machine learning model can be used to update data associated with one or more participants in the participant data store 406 and/or one or more topics in the topic data store 408. The output of the machine learning model based on the information associated with the completed conference may thus refer to changes in understandings of how long it may take for future topics in further future conferences to be addressed.

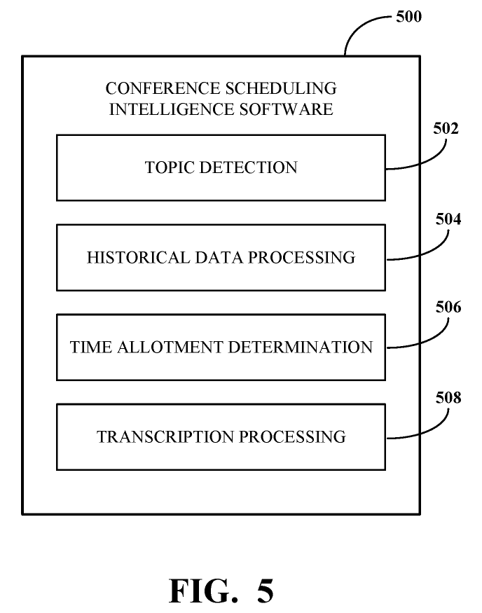

FIG. 5 is a block diagram of example functionality of conference scheduling intelligence software 500, which may, for example, be the conference scheduling intelligence software 402 shown in FIG. 4. The conference scheduling intelligence software 500 includes tools, such as programs, subprograms, functions, routines, subroutines, operations, and/or the like for intelligently recommending time allotments for topics to discuss during future conferences. As shown, the conference scheduling intelligence software 500 includes a topic detection tool 502, a historical data processing tool 504, a time allotment determination tool 506, and a transcription processing tool 508.

The topic detection tool 502 detects a list of topics received from or otherwise based on input received from an operator device, such as the operator device 410 shown in FIG. 4. For example, the input from the operator device may specify the list of topics or information usable to detect topics to put into a list. Detecting the list of topics can include processing the input received from the operator device using keyword recognition. In some cases, the list of topics may be presented within a schedule item being created based on input received from the operator device, in which case the list of topics may be detected within a field of the schedule item.

The historical data processing tool 504 retrieves historical data relevant to the list of topics from one or more data stores, such as the participant data store 406 and/or the topic data store 408 shown in FIG. 4. The historical data processing tool 504 determines the data within those data stores which is relevant based on the list of topics. For example, the historical data processing tool 504 may, based on the identification of a given topic within the list of topics, retrieve historical data associated with a potential participant who has attended one or more past conferences and/or with that topic as discussed in one or more past conferences.

The time allotment determination tool 506 determines the time allotments for the list of topics based on the historical data retrieved from the one or more data stores. The time allotments for individual topics are determined based on the historical data relevant to those topics, such as total or average talk times for those topics and/or by participants associated with those topics. In some cases, the time allotments may be determined based in part on scaling factors indicated for the future conference. For example, the scaling factors may include a total time weight imposing a total or maximum time for the entire future conference. In such a case, the time allotments for individual topics may be scaled according to the time allotments determined for each of the topics of the list of topics. The time allotment determination tool 506 then updates a schedule item for the future conference according to the determined time allotments.

The transcription processing tool 508 uses a transcription of the future conference after it has been completed to update the historical data within one or more data stores. The updates are to talk times for one or more participants who attended the completed conference, one or more topics discussed during the completed conference, or both. The talk times are determined by processing the transcription of the completed conference. For example, total talk times may be computed based on start and end times for individual topics and/or individual participants specified within the transcription.

Although the tools 502 through 508 are shown as functionality of the conference scheduling intelligence software 500 as a single piece of software, in some implementations, some or all of the tools 502 through 508 may exist outside of the conference scheduling intelligence software 500 and/or the software platform may exclude the conference scheduling intelligence software 500 while still including the tools 502 through 508 elsewhere.

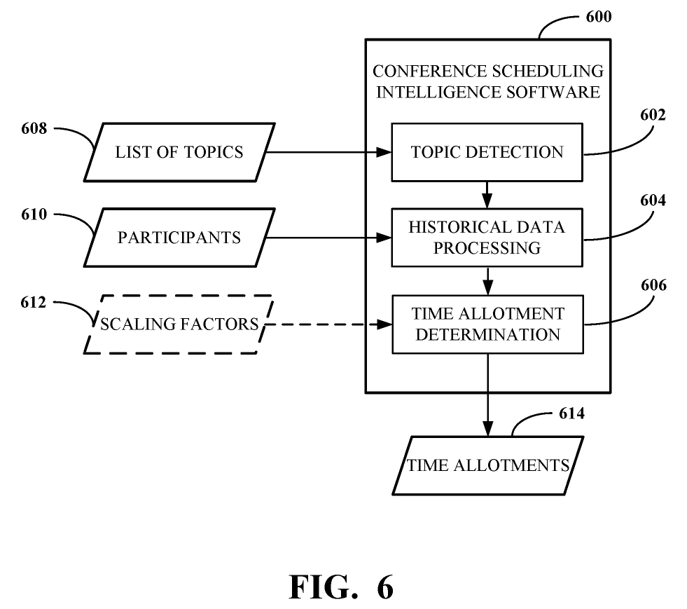

FIG. 6 is a block diagram of an example of conference scheduling intelligence functionality of a future conference time allotment intelligence system. The conference scheduling intelligence functionality is implemented by conference scheduling intelligence software 600, which may, for example, be the conference scheduling intelligence software 500 shown in FIG. 5. The conference scheduling intelligence software 600 includes a topic detection tool 602, a historical data processing tool 604, and a time allotment determination tool 606, which may, for example, be the tools 502 through 506 shown in FIG. 5.

The conference scheduling intelligence software 600 receives as input a list of topics 608, an identification of participants 610, and optional scaling factors 612 and produces as output time allotments 614 determined for the list of topics 608. The input may, for example, be received from an operator device, such as the operator device 410 shown in FIG. 4. The various input is used by different tools of the conference scheduling intelligence software 600. In particular, the list of topics 608 input is used by the topic detection tool 602, the participants 610 input is used by the historical data processing tool 604, and the optional scaling factors 612 input is used by the time allotment determination tool 606.

The topic detection tool 602 outputs an identification of one or more topics detected based on the list of topics 608. The historical data processing tool 604 outputs historical data retrieved from one or more data stores based on the output of the topic detection tool 602 and the participants 610. The time allotment determination tool 606 outputs the time allotments 614 based on the output of the historical data processing tool 604 and the optional scaling factors 612. The time allotments 614 are used to update a schedule item for the future conference such as to indicate those time allotments 614 for respective topics of the list of topics 608.

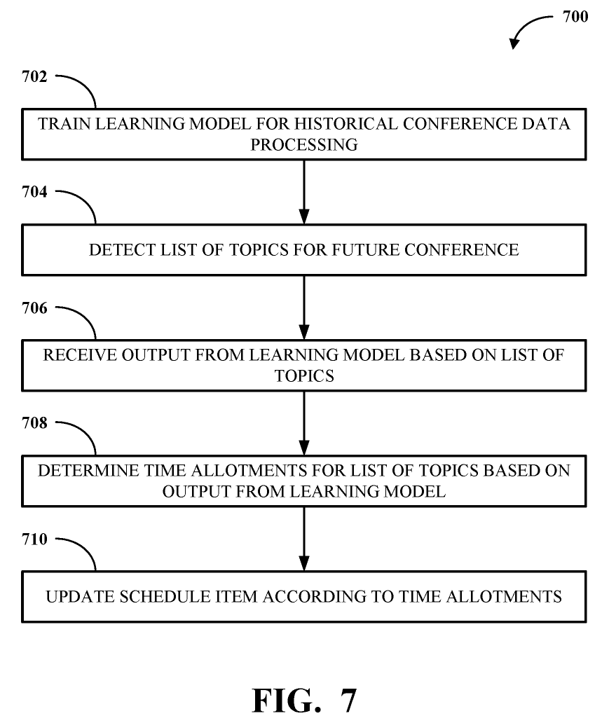

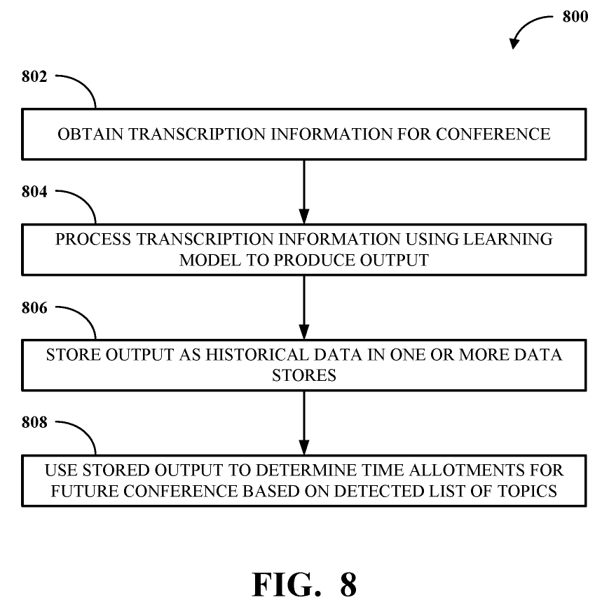

To further describe some implementations in greater detail, reference is next made to examples of techniques which may be performed by or using a system for future conference time allotment intelligence. FIG. 7 is a flowchart of an example of a technique 700 for future conference time allotment intelligence. FIG. 8 is a flowchart of an example of a technique 800 for using conference transcription information to update historical data stores for future conference time allotment intelligence.

The technique 700 and/or the technique 800 can be executed using computing devices, such as the systems, hardware, and software described with respect to FIGS. 1-6. The technique 700 and/or the technique 800 can be performed, for example, by executing a machine-readable program or other computer-executable instructions, such as routines, instructions, programs, or other code. The steps, or operations, of the technique 700 and/or the technique 800 or another technique, method, process, or algorithm described in connection with the implementations disclosed herein can be implemented directly in hardware, firmware, software executed by hardware, circuitry, or a combination thereof.

For simplicity of explanation, the technique 700 and the technique 800 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 7, the technique 700 for future conference time allotment intelligence is shown. At 702, a learning model is trained for historical conference data processing. Training the learning model for historical data processing includes using a data set of participant data and topic data to train the learning model to recognize participant information and topic information within input including a list of topics for a future conference.

At 704, a list of topics for a future conference is detected. The list of topics is detected based on input received from an operator device. In some cases, the list of topics is received at one time, such as where the input is received after the list of topics or information usable to detect the operator device is entered at the operator device. In some cases, the list of topics is received in real-time such that individual topics are detected before next information usable to detect next topics are received.

At 706, output from the learning model is received based on the list of topics. The output of the learning model includes historical conference data retrieved from one or more data stores based on the list of topics. For example, the learning model can output data retrieved from the data stores or identifications of certain data within those data stores. The learning model produces or otherwise identifies or obtains the output based on the list of topics and in some cases also based on a list of potential participants identified for the future conference.

At 708, time allotments for the list of topics are determined based on the output from the learning model. The time allotments represent recommendations of amounts of time to spend during the future conference discussing respective topics on the list of topics. Determining the time allotments includes using the historical conference data identified in the output from the learning model to determine recommended times for some or all of the topics on the list of topics. For example, total or average talk times for various topics and/or total or average talk times for various participants as indicated in the historical conference data processed by the learning model may indicate whether certain topics tend to take longer than expected or less time than expected and/or whether certain participants tend to talk for longer or shorter amounts of time than are expected.

At 710, a schedule item is updated according to the time allotments. The schedule item may be created before the time allotments are determined. In some cases, the schedule item may include initial time allotments which may then be updated based on the determined time allotments, such as to adjust those initial time allotments based on the processing performed. In some cases, the schedule item may be created as part of the process for determining the time allotments. In some implementations, the schedule item may be an invitation to be transmitted to one or more participant devices associated with the named participants.

Referring next to FIG. 8, the technique 800 for using conference transcription information to update historical data stores for future conference time allotment intelligence is shown. At 802, transcription information is obtained for a conference which has completed. The transcription may be generated by the conferencing software that facilitates the conference or by other software in communication with that conferencing software.

At 804, the transcription information is processed using a learning model to produce output. The transcription information identifies start times and end times during which certain participants spoke. Those start and end times can be computed to determine a total talk time for each participant during the conference. Those start and end times may also be processed along with the content associated therewith to determine total talk times for certain topics discussed during the conference regardless of the participant.

At 806, the output is stored as historical data in one or more data stores. The output is used to update recommendations for future conferences such as by adjusting one or more total talk time data and/or one or more average talk time data for participants and/or topics.

At 808, the stored output is used to determine time allotments for a future conference based on a list of topics detected for that future conference. For example, the stored output may be used as described with respect to the technique 700 shown in FIG. 7.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
receiving an input to schedule a future conference, the input identifying a list of topics and a total time scheduled for the future conference;
determining time allotments for the list of topics based on historical conference data;
scaling the time allotments based on a total time weight indicative of the total time to generate scaled time allotments within that total time; and
updating a schedule item for the future conference to include the scaled time allotments for the list of topics.

2. The method of claim 1, further comprising:
using one or more additional scaling factors to scale the time allotments, wherein the one or more additional scaling factors include at least one of:
a temporal relevance weight that scales one or more of the time allotments based on how soon an event associated with a respective topic from the list of topics is to the future conference;
a total participants weight that scales one or more of the time allotments based on a total number of participants for the future conference; or
a topic frequency weight that scales one or more of the time allotments based on a frequency with which a same topic from the list of topics is discussed in past conferences.

3. The method of claim 2, wherein the one or more additional scaling factors include the temporal relevance weight, and using the one or more additional scaling factors to scale the time allotments comprises:
determining that a first topic of the list of topics corresponds to an event occurring within a threshold time period from a scheduled date of the future conference; and
increasing a time allotment for the first topic using the temporal relevance weight.

4. The method of claim 2, wherein the one or more additional scaling factors include the total participants weight, and wherein using the one or more additional scaling factors to scale the time allotments comprises:
determining that the total number of participants identified for the future conference exceeds a threshold number of participants; and
increasing one or more of the time allotments based on the total participants weight.

5. The method of claim 2, wherein the one or more additional scaling factors include the topic frequency weight, and wherein using the one or more additional scaling factors to scale the time allotments comprises:
determining that a third topic of the list of topics has been discussed in regularly occurring conferences; and
decreasing a time allotment for the third topic based on the topic frequency weight.

6. The method of claim 2, wherein the one or more additional scaling factors include the topic frequency weight, and wherein using the one or more additional scaling factors to scale the time allotments comprises:
determining that a fourth topic of the list of topics has not been discussed for at least a threshold number of regularly occurring conferences; and
increasing a time allotment for the fourth topic based on the topic frequency weight.

7. The method of claim 1, wherein obtaining the historical conference data comprises:
retrieving, from a participant data store, participant data for one or more participants identified for the future conference; and
retrieving, from a topic data store, topic data for one or more topics from the list of topics.

8. The method of claim 7, wherein the participant data for a given participant includes: a total amount of time the given participant spoke during a given past conference; an average amount of time the given participant spoke across all past conferences attended by the given participant; and a number of past conferences attended by the given participant.

9. A system, comprising:
one or more memories; and
one or more processors, the one or more processors configured to execute instructions stored in the one or more memories to:
receive an input to schedule a future conference, the input identifying a list of topics and a total time scheduled for the future conference;
determine time allotments for the list of topics based on historical conference data;
scale the time allotments based on a total time weight indicative of the total time to generate scaled time allotments within that total time; and
update a schedule item for the future conference to include the scaled time allotments for the list of topics.

10. The system of claim 9, wherein, to determine the time allotments, the one or more processors configured to execute instructions stored in the one or more memories to:
process the list of topics and the historical conference data using a machine learning model trained to recognize participant information and topic information,
wherein the machine learning model is trained using a data set comprising participant data and topic data from a plurality of past conferences.

11. The system of claim 9, the one or more processors further configured to execute instructions in the one or more memories to:
identify one or more participants to invite to the future conference based on the list of topics.

12. The system of claim 11, wherein, to identify the one or more participants, the one or more processors configured to execute instructions stored in the one or more memories to:
process the list of topics using a machine learning model to evaluate content and context of the list of topics against data representing at least one of skills, past projects, organization chart information, or job title information for personnel associated with an organization; and
determine one or more persons who are knowledgeable about one or more topics of the list of topics based on output from the machine learning model.

13. The system of claim 9, wherein, to update the schedule item, the one or more processors configured to execute instructions stored in the one or more memories to:
responsive to a determination that the schedule item includes initial time allotments for the list of topics, update the initial time allotments based on the scaled time allotments.

14. The system of claim 9, wherein, to update the schedule item, the one or more processors configured to execute instructions stored in the one or more memories to:
responsive to a determination that the schedule item omits initial time allotments, add the scaled time allotments to the schedule item.

15. One or more non-transitory computer-readable storage media comprising instructions that, when executed by one or more processors, perform operations comprising:
receiving an input to schedule a future conference, the input identifying a list of topics and a total time scheduled for the future conference;
determining time allotments for the list of topics based on historical conference data;
scaling the time allotments based on a total time weight indicative of the total time to generate scaled time allotments within that total time; and
updating a schedule item for the future conference to include the scaled time allotments for the list of topics.

16. The one or more non-transitory computer-readable storage media of claim 15, the operations further comprising:
transmitting a calendar invitation to one or more participant devices associated with participants identified for the future conference.

17. The one or more non-transitory computer-readable storage media of claim 15, wherein the input is received in real-time, and wherein updating the schedule item comprises:
detecting individual topics from the list of topics as the input is received;
determining individual time allotments for the individual topics as each individual topic is detected; and
generating the schedule item progressively based on the individual topics and the individual time allotments.

18. The one or more non-transitory computer-readable storage media of claim 15, the operations further comprising:
after the future conference has been completed, obtaining transcription information for the future conference, the transcription information identifying start times and end times during which participants spoke and topics were discussed;
processing the transcription information using a machine learning model to determine talk times for the participants and the topics during the future conference; and
updating the historical conference data in a data store based on the talk times.

19. The one or more non-transitory computer-readable storage media of claim 18, wherein updating the historical conference data comprises:
updating participant data for one or more participants who attended the future conference based on talk times for the one or more participants; and
updating topic data for one or more topics discussed during the future conference based on the talk times for the one or more topics.

20. The one or more non-transitory computer-readable storage media of claim 15, wherein the historical conference data is obtained from one or more data stores comprising at least one of: a participant data store storing first historical data associated with first time amounts individual participants spoke across one or more past conferences; or a topic data store storing second historical data associated with second time amounts used in discussing individual topics across the one or more past conferences.
